(19) United States
(12) Patent Application Publication
(10) Pub. No.: US 2004/0154142 A1
(43) Pub. Date: Aug. 12, 2004

(54) Sight gauge hose clamp

(76) Inventors: David Capra, East Hanover, NJ (US); Steven Capra, East Hanover, NJ (US)

Correspondence Address: David Capra, P.O. Box 72, East Hanover, NJ, 07936, US

(21) Appl. No.: 10/364,007

(22) Filed: Feb. 12, 2003

(51) Int. Cl. F16L 33/00

(52) U.S. Cl. 24/278

(57) ABSTRACT

A clamp has two molded clamp C-Shaped halves 1, 2 C-halves held together by a two screws 3 and a nut 4.

The C-shaped halves have a 20 degree tapered slot 6 along the inside.

The slot 6 fits the same angled flange 7 on the end of a tube 8.

In use, this slot 6 holds flanges 7 on tubes 8 with a gasket 9 together in alignment.

Both C-shaped clamp halves have two holes 5.

Each C-shaped halve has two holes into which the thread 3 go threw to be screwed into a nut 4 to clamp C-halves 1,2 together.

### BACKGROUND OF INVENTION

We make a true union clamp in plastic also other clamps are made in stainless steel.

But neither give a clear visual of the seal at all times.

You are unable to check for leaks or contamination with these clamps.

### SUMMARY OF INVENTION

The object of the invention is a simple streamlined clamp that creates a 360 degree complete full pressure seal without any pressure points and is made of clear plastic to show a visual of tri clamp and gasket sealed area to show user no leaking or contamination build up between sealed tubes. When clamp is fully tightened user is unable to over tighten to create a perfect seal every time.

### BRIEF DESCRIPTION OF THE DRAWINGS

FIG. 1 is a ¾ view of a clamp in the open position.

FIG. 2 is a ¾ view of a clamp in the closed position.

FIG. 3 is a plain top view of the clamp.

FIG. 4 is a cross section top view of a clamp connecting tubes together with a gasket.

### DETAILED DESCRIPTION OF DRAWINGS

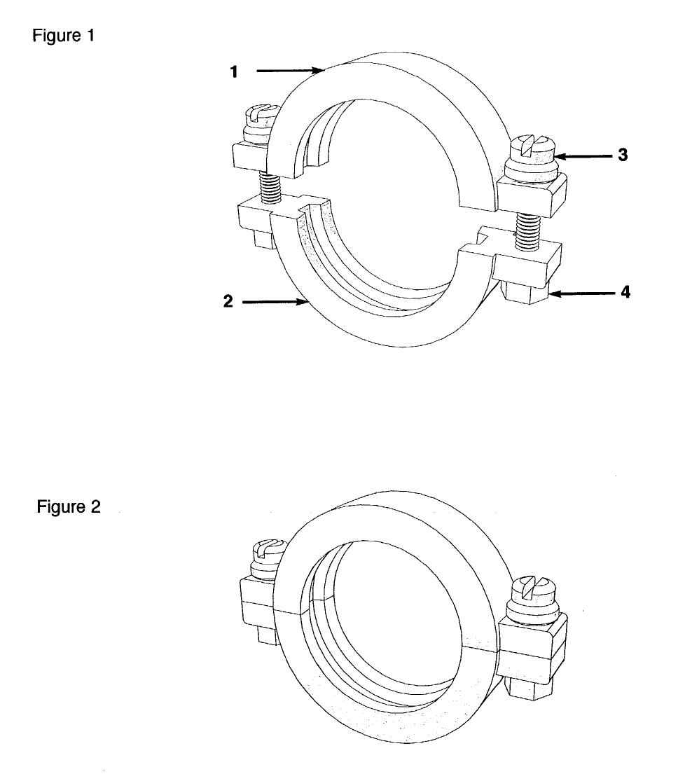

FIG. 1. A clamp has two molded clamp C-Shaped halves 1, 2 C-halves held together by a two screws 3 and a nut 4. The C-shaped halves have a 20 degree tapered slot 6 along the inside. The slot 6 fits the same angled flange 7 on the end of a tube 8.

In use, this slot 6 holds flanges 7 on tubes 8 with a gasket 9 together in alignment.

Both C-shaped clamp halves have two holes 5. Each C-shaped halve has two holes into which the thread 3 go threw to be screwed into a nut 4 to clamp C-halves 1,2 together. FIG. 2. A clamp has two molded clamp C-Shaped halves 1, 2 C-halves held together by a two screws 3 and a nut 4. The C-shaped halves have a 20 degree tapered slot 6 along the inside. The slot 6 fits the same angled flange 7 on the end of a tube 8.

In use, this slot 6 holds flanges 7 on tubes 8 with a gasket 9 together in alignment.

Both C-shaped clamp halves have two holes 5. Each C-shaped halve has two holes into which the thread 3 go threw to be screwed into a nut 4 to clamp C-halves 1,2 together.

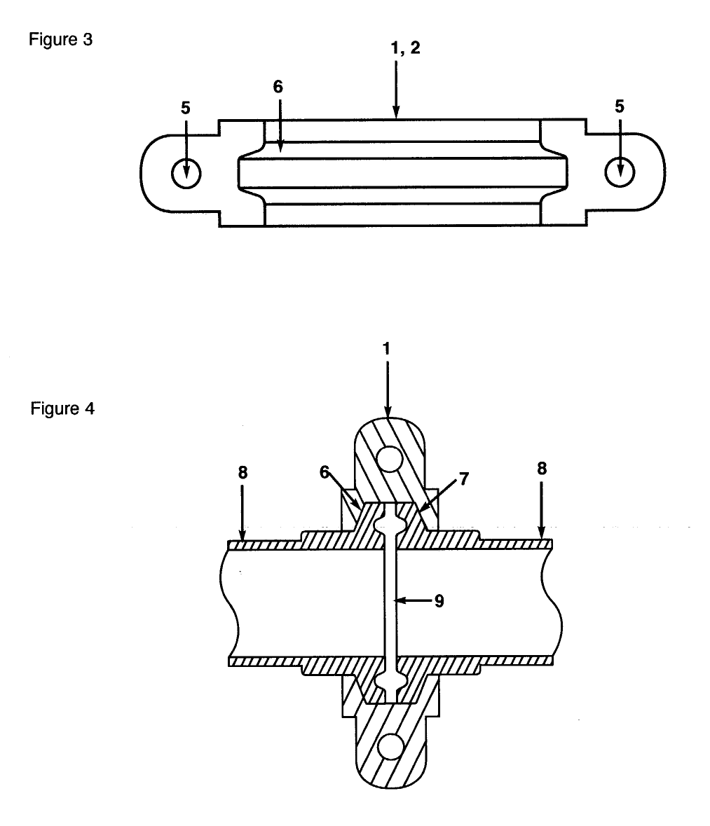

FIG. 3 is a plain top view of the clamp 1, 2. The C-shaped halves have a 20 degree tapered slot 6 along the inside. Each C-shaped halves 1, 2 have two holes 5.

FIG. 4 is a cross section top view of a clamp 1 connecting tubes 8 together with a gasket 9. The C-shaped halves have a 20 degree tapered slot 6 along the inside.

The slot 6 fits the same angled flange 7 on the end of a tube 8.

In use, this slot 6 holds flanges 7 on tubes 8 with a gasket 9 together in alignment.

We claim:

1. A simple streamlined clamp that creates a 360 degree complete full pressure seal without any pressure points and is made of clear plastic to show a visual of tri clamp and gasket sealed area to show user no leaking or contamination build up between sealed tubes.

2. A clamp comprises of two C-shaped halves, each halve has two holes. The Holes are positioned at each end of the C-shaped Halve.
A screw goes threw the hole. The screw is attached to a nut witch is used to tighten the clamp halves together.

3. When clamp is fully tightened user is unable to over tighten to create a perfect seal every time.
